(19) United States
(12) Patent Application Publication
(10) Pub. No.: US 2026/0298549 A1
(43) Pub. Date: Oct. 1, 2026

(54) MODULAR MASS TRANSFER PACKING SYSTEM WITH INTEGRATED HEAT TRANSFER

(71) Applicant: RESEARCH TRIANGLE INSTITUTE, Research Triangle Park, NC (US)

(72) Inventors: PAUL DAVID MOBLEY, Raleigh, NC (US); JAK TANTHANA, Durham, NC (US); VIJAY GUPTA, Cary, NC (US); COLIN TART, Garner, NC (US)

(21) Appl. No.: 19/490,928

(22) PCT Filed: Jun. 5, 2024
(86) PCT No.: PCT/US2024/032659

§ 371 Date: Dec. 6, 2025

Related U.S. Application Data
(60) Provisional application No. 63/506,671, filed on Jun. 7, 2023.

(51) Int. Cl. F28D 19/04

(52) U.S. Cl. CPC F28D 19/04

(57) ABSTRACT

A heat and mass transfer assembly is described, which in various implementations may be constituted as a packing element including a plate array including heat transfer plates and mass transfer plates in a modular structure in which the number of heat transfer plates and mass transfer plates may be varied to effect desired levels of heat and mass transfer, and multiple packing elements can be integrated in a heat and mass transfer packing assembly, to carry out a wide variety of fluid contacting processes.

### CROSS-REFERENCE TO RELATED APPLICATION

The benefit of under 35 USC § 119 of U.S. Provisional Patent Application 63/506,671 filed Jun. 7, 2023 in the names of Paul Mobley, Jak Tanthana, Vijay Gupta, and Colin Tart for “MODULAR MASS TRANSFER PACKING SYSTEM WITH INTEGRATED HEAT TRANSFER” is hereby claimed, and the disclosure thereof is hereby incorporated herein by reference in its entirety, for all purposes.

### GOVERNMENT RIGHTS IN THE INVENTION

This invention was made with government support under DE-EE 0009415 awarded by the U.S. Department of Energy. The government has certain rights in the invention.

### FIELD

The present disclosure relates to packing assemblies, subassemblies, and plate assemblies for providing heat and mass transfer in fluid contacting apparatus to enhance the efficiency of such apparatus, as well as to contacting apparatus comprising such packing assemblies, packing subassemblies, and/or plate assemblies.

In specific aspects, the present disclosure relates to modular mass transfer packing subassemblies having integrated heat transfer capability enabling removal or supply of heat at a locus of exothermicity or endothermicity, to packing assemblies of such modular mass transfer packing subassemblies, and to fluid contacting vessels containing such subassemblies and assemblies, e.g., absorption, regeneration, reaction, extraction, distillation, and other gas/liquid contacting vessels. The modular mass transfer packing subassemblies are readily integratable via heat transfer fluid interconnections, to form packing assemblies with a variety of form factors and configurations.

### BACKGROUND

Fluid contacting operations are extensively used in many industrial applications in which respective fluids are contacted to effect mass transfer from one fluid to another. Such applications may for example include absorption, regeneration, reaction, distillation, extraction, and other fluid contact, e.g., gas/liquid contacting, processes. In many such applications, the fluid contacting operation is accompanied by substantial exothermic or endothermic effects that must be modulated in order to ensure efficient processing of the associated fluids.

As a specific example of the aforementioned fluid contacting operations, packed column absorbers may be utilized to achieve removal of impurities or other specific components from multicomponent fluids by absorption in a solvent medium. In operation, the multicomponent fluid and the solvent medium are flowed through the packed column for contacting with one another, with the packing providing extensive surface area facilitating the multicomponent fluid/solvent medium contacting. The absorption process in the packed column may be accompanied by significant generation of heat, requiring the solvent medium to be physically removed from the packed column, exteriorly cooled, and returned to the column for renewed contacting.

In addition to heat of absorption effects in packed column absorption applications, other fluid contacting operations carried out in vessels containing packing may involve undesired thermal effects resulting from changes in pressure, flow rate, and/or composition of fluids, phase change of fluids, chemical reaction of fluids, and other stimuli and conditions. In this respect, the packing material that is utilized in the vessel to provide extended area to enhance mass transfer between the fluids being contacted, may itself respond to adverse thermal effects in the vessel as a “thermal ballast” heat source or heatsink that functions to resist or impede corrective heat removal or heating that would otherwise modulate the adverse thermal effects.

Thus, the mass transfer that is facilitated by the vessel packing may also be accompanied by thermal effects that serve to impair the mass transfer operation.

In consequence of the foregoing considerations, the art continues to seek improvements in packing structures and arrangements, and fluid contacting vessels comprising same.

### SUMMARY

The present disclosure relates to packing assemblies, subassemblies, and plate assemblies for providing heat and mass transfer in fluid contacting apparatus to enhance the efficiency of such apparatus, as well as to contacting apparatus comprising such packing assemblies, packing subassemblies, and/or plate assemblies. In specific aspects, the present disclosure relates to modular mass transfer packing subassemblies having integrated heat transfer capability enabling removal or supply of heat when operatively disposed at a locus of exothermicity or endothermicity, as well as to packing assemblies comprising such modular mass transfer packing subassemblies and to fluid contacting vessels comprising such subassemblies and assemblies.

In one aspect, the disclosure relates to a heat and mass transfer assembly for a fluid contacting apparatus, the heat and mass transfer assembly comprising a packing element comprising a plate array including heat transfer plates and mass transfer plates arranged to contact respective fluids on the mass transfer plates, the heat transfer plates including interior heat exchange passages, the packing element further comprising heat exchange fluid flow circuitry connected to the heat transfer plates in the plate array to flow heat exchange fluid through the heat transfer plates in the interior heat exchange passages thereof and to discharge heat exchanged fluid from the heat transfer plates.

The disclosure relates in another aspect to a heat and mass transfer assembly comprising an integrated array of a multiplicity of such packing elements.

Another aspect of the disclosure relates to a fluid contacting apparatus comprising the heat and mass transfer assembly as variously described herein.

A further aspect of the disclosure relates to a fluid contacting process, comprising contacting fluids to effect mass transfer from one fluid to another fluid, wherein the contacting involves or mediates thermal effects, and wherein the contacting is carried out in a heat and mass transfer assembly as variously described herein or in a fluid contacting apparatus as variously described herein.

Another aspect of the disclosure relates to a spot weld tufted heat and mass transfer plate comprising walls bonded to one another along their periphery and at spot welds spaced apart from one another so that the walls enclose and define an interior passage, a heat exchange fluid inlet and a heat exchange fluid outlet in communication with the interior passage, and an orifice in at least some of the spot welds.

Yet another aspect of the disclosure relates to a gas-liquid contacting plate array comprising mass transfer plates arranged in substantially parallel horizontal alignment and vertically spaced apart relationship to one another in the plate array, with each mass transfer plate being perforate or permeable for gas upflow therethrough and having a top surface for support of liquid thereon, and with each mass transfer plate in the plate array terminating at a discharge edge above and overlying the top surface of a next-lower mass transfer plate in the plate array so that liquid discharged from an overlying mass transfer plate flows over the discharge edge thereof and falls through a discharge space onto the top surface of the next-lower mass transfer plate in the plate array, the gas-liquid contacting plate array further comprising a heat pipe positioned so that a heat exchange section thereof is disposed in the discharge space of a mass transfer plate in the gas-liquid contacting plate array.

Other aspects, features and embodiments of the disclosure will be more fully apparent from the ensuing description and appended claims.

### BRIEF DESCRIPTION OF THE DRAWINGS

FIG. 1 is a schematic representation of a packing element assembly comprising a plurality of packing element subassemblies, according to one aspect of the present disclosure.

FIG. 2 is a perspective view of a fluid contacting packing assembly comprising an array of heat transfer plate and mass transfer plate subassemblies, according to one embodiment of the present disclosure.

FIGS. 3-5 are perspective views of respective portions of the fluid contacting packing assembly of FIG. 2, showing details of construction thereof.

FIG. 6 is a perspective view of subassemblies (A), (B), and (C) of a fluid contacting packing assembly in which adjacent ones of the successive subassemblies are interconnected by heat exchange fluid manifold connectors for flow of heat exchange fluid from the horizontal heat exchange conduit containing heat exchange conduit fluid passages in subassembly (A) through the successive subassemblies to the horizontal heat exchange conduit containing heat exchange conduit fluid passages in subassembly (C), with arrows showing the path of heat exchange fluid flow through the subassemblies.

FIG. 7 is an elevation view of a portion of a fluid contacting packing assembly including a multiplicity of heat transfer plate and mass transfer plate subassemblies, and associated heat exchange manifold.

FIG. 8 is a photograph of heat transfer plate and mass transfer plate subassemblies formed by additive manufacturing for a fluid contacting packing assembly comprising the subassemblies.

FIG. 9A is a perspective view of a fluid contacting packing assembly of heat transfer plates and mass transfer plates, in a cylindrical packing assembly conformation.

FIG. 9B is a top plan view of a portion of a fluid contacting apparatus including a cylindrical vessel containing hexagonal fluid contacting packing subassemblies of heat transfer plates and mass transfer plates, arranged with flow circuitry for circulation of heat transfer fluid through the subassemblies.

FIG. 10 shows a fluid contacting heat transfer and mass transfer pillow plate packing element, according to one embodiment of the present disclosure.

FIG. 11 is a sectional elevation view of a fluid contacting apparatus according to one aspect of the present disclosure, including heat and mass transfer plates, and illustrating the fluid flows in such apparatus.

FIG. 12 is a wavy pillow plate precursor structure utilized for forming wavy heat and mass transfer pillow plates.

FIG. 13 is an assembly of wavy heat and mass transfer pillow plates as pressure expanded to constitute heat transfer fluid flow passages therein.

FIG. 14 is a schematic illustration of a fluid contacting apparatus containing a packing assembly, according to one embodiment of the present disclosure.

FIG. 15 is a schematic illustration of a fluid contacting apparatus according to another embodiment of the present disclosure, in which fluid contacting plates are disposed in the interior volume of a fluid contacting vessel with heat pipes being arranged in the liquid downcomer flow path to effect liquid cooling.

### DETAILED DESCRIPTION

The present disclosure relates to packing assemblies, subassemblies, and plate assemblies for providing heat and mass transfer in fluid contacting apparatus to enhance the efficiency of such apparatus, as well as to contacting apparatus comprising such packing assemblies, packing subassemblies, and/or plate assemblies.

As used herein and in the appended claims, the singular forms “a”, “an”, and “the” include plural referents unless the context clearly dictates otherwise.

The disclosure, as variously set out herein in respect of features, aspects and embodiments thereof, may in particular implementations be constituted as comprising, consisting, or consisting essentially of, some or all of such features, aspects and embodiments, as well as elements and components thereof being aggregated to constitute various further implementations of the disclosure. The disclosure is set out herein in various embodiments, and with reference to various features and aspects of the disclosure. The disclosure contemplates such features, aspects and embodiments in various permutations and combinations, as being within the scope of the invention. The disclosure may therefore be specified as comprising, consisting or consisting essentially of, any of such combinations and permutations of these specific features, aspects and embodiments, or a selected one or ones thereof.

The present disclosure in various aspects relates to heat and mass transfer assemblies for fluid contacting apparatus.

In one aspect, the disclosure relates to a heat and mass transfer assembly for a fluid contacting apparatus, the heat and mass transfer assembly comprising a packing element comprising a plate array including heat transfer plates and mass transfer plates arranged to contact respective fluids on the mass transfer plates, the heat transfer plates including interior heat exchange passages, the packing element further comprising heat exchange fluid flow circuitry connected to the heat transfer plates in the plate array to flow heat exchange fluid through the heat transfer plates in the interior heat exchange passages thereof and to discharge heat exchanged fluid from the heat transfer plates.

Such heat and mass transfer assembly may be constituted with any of the features, and in any of the arrangements, described below.

In heat and mass transfer assembly, the heat transfer plates may be of any suitable size, shape, construction, an arrangement. In various embodiments, the heat transfer plates may comprise at least one plate selected from the group consisting of spot weld tufted heat transfer plates, brazed sheet heat transfer plates, and plate and frame heat transfer plates. The plate array in various embodiments comprises alternating heat transfer plates and mass transfer plates. In other embodiments, the number of heat transfer plates in the plate array is less than or more than the number of mass transfer plates in the plate array.

As indicated, the heat transfer plates and mass transfer plates may be of any suitable character, and may for example be of square, rectangular, or other polygonal shape.

The packing element may correspondingly be of any appropriate form and geometry appropriate to the fluid contacting operation. In specific embodiments, the packing element may be of cubic or rectangle or parallelepiped form. In other embodiments, the packing element may be of cylindrical form or of hexagonal form or of other polygonal form.

The heat and mass transfer assembly may be constructed and arranged, wherein the heat exchange fluid flow circuitry of the packing element comprises a manifold heat exchange fluid supply conduit having flow connections to each of the heat transfer plates in the plate array, and/or wherein the heat exchange fluid flow circuitry of the packing element comprises a manifold heat exchange fluid discharge conduit having flow connections to each of the heat transfer plates in the plate array.

The heat and mass transfer assembly may advantageously comprise an integrated array of a multiplicity of the packing elements. In such integrated array of packing elements, heat exchange fluid flow circuitry of each packing element may be coupled with heat exchange fluid flow circuitry of at least one other packing element in the integrated array. In various implementations, flow passages between adjacent plates in the packing elements in the integrated array made the aligned with flow passages between adjacent plates in one or more other packing elements in the integrated array, although any other suitable configurations arrangements may be employed in the fluid contacting operation.

The heat transfer plates in the heat and mass transfer assembly may be of any suitable type. As an example, the heat transfer plates may comprise a multiplicity of spot weld tufted heat transfer plates. In embodiments, spot welds on the spot weld tufted heat transfer plates may define a geometrically regular array of spot welds, or the spot welds on the spot weld tufted heat transfer plates may define a geometrically irregular array of spot welds.

In various embodiments, the spot weld tufted heat transfer plates may be configured with at least some of the spot welds on the spot weld tufted heat transfer plates having an orifice therein. In specific plate structures, at least a majority of the spot welds on the spot weld tufted heat transfer plates may have an orifice therein. In other plate structures, all or substantially all of the spot welds on the spot weld tufted heat transfer plates may have an orifice therein.

It will be correspondingly recognized that spot weld tufted heat transfer plates may be of varied forms and constructions. In specific embodiments, the spot weld tufted heat transfer plates may have a wavy conformation, as described more fully hereinafter.

In other embodiments of the heat and mass transfer assembly of the disclosure, the heat transfer plates may comprise a multiplicity of brazed sheet heat transfer plates, in which the sheets are bonded together at their peripheral edges to define an enclosed interior heat transfer fluid flow channel, with appropriate inlet and outlet structures for circulation of heat transfer fluid through the interior heat transfer fluid flow channel.

In still other embodiments of the heat and mass transfer assembly of the disclosure, the heat transfer plates may comprise a multiplicity of plate and frame heat transfer plates.

The heat transfer plates in the heat of mass transfer assembly of the present disclosure may be widely varied in structure, and may comprise extended heat transfer surface elements such as fins, disposed internally and/or externally in the heat transfer plate structure, and the heat transfer plates may also employ augmentative heat transfer elements such as turbulators disposed in the interior heat transfer fluid flow channels of the plates.

The disclosure relates in another aspect thereof to a fluid contacting apparatus, comprising a heat mass transfer assembly as variously described herein. The fluid contacting apparatus in various embodiments may comprise a fluid contacting vessel in which the heat and mass transfer assembly is disposed. The fluid contacting vessel may be of any suitable size, shape, orientation and arrangement, and may for example comprise a cylindrical contacting vessel.

The disclosure in a further aspect relates to a fluid contacting process, comprising contacting fluids to effect mass transfer from one fluid to another fluid, wherein the contacting involves or mediates thermal effects, and wherein the contacting is carried out in a heat and mass transfer assembly as variously described herein or in a fluid contacting apparatus as variously described herein.

Such fluid contacting process may be of any suitable type, and may for example comprise absorption, regeneration, reaction, distillation, or extraction. In specific embodiments, the fluid contacting process may comprise gas-liquid contacting, such as contacting of a CO₂-containing gas with a solvent to absorb CO₂ by the solvent from the CO₂-containing gas.

The fluid contacting process in various embodiments may involve or mediate exothermic thermal effects. In other embodiments, the fluid contacting process may involve or mediate endothermic thermal effects.

In various embodiments of the fluid contacting process, the heating mass transfer assembly may be employed to operatively control a temperature bulge in a fluid contacting vessel and reduces emissions due to aerosol growth in the fluid contacting vessel.

Another aspect of the disclosure relates to a spot weld tufted heat and mass transfer plate comprising walls bonded to one another along their periphery and at spot welds spaced apart from one another so that the walls enclose and define an interior passage, with a heat exchange fluid inlet and a heat exchange fluid outlet in communication with the interior passage, and an orifice in at least some of the spot welds.

A further aspect of the disclosure relates to a heat and mass transfer assembly, comprising a stacked arrangement of such spot weld tufted heat and mass transfer plates.

Another aspect of the disclosure relates to a gas-liquid contacting plate array comprising mass transfer plates arranged in substantially parallel horizontal alignment and vertically spaced apart relationship to one another in the plate array, with each mass transfer plate being perforate or permcable for gas upflow therethrough and having a top surface for support of liquid thereon, and with each mass transfer plate in the plate array terminating at a discharge edge above and overlying the top surface of a next-lower mass transfer plate in the plate array so that liquid discharged from an overlying mass transfer plate flows over the discharge edge thereof and falls through a discharge space onto the top surface of the next-lower mass transfer plate in the plate array, the gas-liquid contacting plate array further comprising a heat pipe positioned so that a heat exchange section thereof is disposed in the discharge space of a mass transfer plate in the gas-liquid contacting plate array.

Such gas-liquid contacting plate array may be constituted in various embodiments, with each mass transfer plate in the gas-liquid contacting plate array being perforate for gas upflow therethrough. In other embodiments, the gas and liquid contacting plate array may be constituted, with each mass transfer plate in the gas-liquid contacting plate array is permeable for gas upflow therethrough. In various embodiments, the heat exchange section of the heat pipe is a vaporization section of the heat pipe. In other embodiments, the heat exchange section of the heat pipe is a condensation section of the heat pipe. In still other embodiments, the gas-liquid contacting plate array may comprise a multiplicity of heat pipes positioned so that heat exchange sections thereof are disposed in the discharge space of a mass transfer plate in the gas-liquid contacting plate array.

The fluids that are involved in the fluid contacting in the apparatus and processes of the present disclosure may be of any suitable type or types, including gas, vapor, or liquid, or a multiphase fluid comprising one or more of such fluid phases. The fluids may be of any suitable composition, with respect to which heat and mass transfer are performed in the operation of the contacting apparatus.

The fluid contacting operation may involve absorption, regeneration, reaction, extraction, distillation or other processes. By way of example, a fluid contacting apparatus and process employing a heat and mass transfer assembly of the present disclosure may be configured for acid gas removal from the gas stream, such as removal of CO₂ from CO₂-containing gas by contacting such gas with an aqueous or non-aqueous or water-lean solvent. These solvents may be used to capture CO₂ from CO₂-containing flue gas streams, in which significant heat is generated by the CO₂ absorption in the solvent. In such applications, the solvent efficiency for CO₂ capture may be adversely impacted at higher temperatures, and an optimal temperature profile may be different for each solvent, as trade-offs in increased kinetic rates at higher temperatures are balanced with vapor-liquid equilibrium. Thus, introducing cooling at optimal locations in the absorption process improves the efficiency of the reaction. Such cooling is provided in a highly effective manner by the heat and mass transfer assembly of the present disclosure, as configured to modulate and thermally manage the absorption process. In this respect, increasing absorption efficiency enables smaller absorption vessels to be utilized, with consequent reduction of capital and operating costs for the absorption system.

It is to be recognized that the gas-liquid contacting operation or other fluid contacting applications may involve heating, such as where a gas-liquid contacting absorption operation is endothermic in character. In still other operations and applications, it may be necessary or desirable to utilize the heat and mass transfer assembly to provide cooling in some sections of the fluid contacting vessel and to provide heating in other sections of the contacting vessel, so that different sections of the fluid contacting vessel are cooled or warmed depending on the optimal process conditions for the solvent and gas, or other contacting fluids used in the fluid contacting operation.

Thus, the heat and mass transfer assembly may be configured to provide differing types and levels of heat exchange in the various regions in the fluid contacting vessel, to provide heating and/or cooling for an optimal thermal profile or condition in the process. In various applications, the heat and mass transfer assembly may be configured to maintain a setpoint temperature or temperature range in the contacting operation, e.g., to isothermalize the contacting operation. In other applications, such as gas-liquid contacting in which the absorption of a gas component in the liquid exhibits significant exothermic effect, the heat and mass transfer assembly may be configured to provide distributed cooling in the contacting vessel to control a temperature bulge in the contacting vessel and reduce emissions due to aerosol growth in the vessel.

The heat and mass transfer assembly of the present disclosure enables removal or provision of heat at contacting vessel regions of exothermicity or endothermicity, respectively, and thereby can effect substantial reductions of contacting vessel size and associated capital equipment, operational and maintenance expenses. The heat and mass transfer assembly may be readily adapted to provide a level of heat transfer that is minimally necessary for isothermal operation or as necessary to achieve optimal temperature distribution, while achieving maximally effective mass transfer.

In the heat and mass transfer assembly comprising the packing element(s), the plate array as previously discussed may comprise alternating heat transfer plates and mass transfer plates, so that a same or similar number of each of such plate types is provided, or the number of heat transfer plates in the plate array may be less than or more than the number of mass transfer plates in the plate array. The heat transfer plates and mass transfer plates in the plate array may be of any suitable shape, e.g., square, rectangular, or other shape. Correspondingly, the packing element(s) may be of any suitable form, e.g., cubic, rectangular parallelepiped, cylindrical, or other form.

The packing element may be formed of any suitable materials of construction, as for example metals, polymeric materials, flexible ceramics, composites, etc.

The heat exchange fluid flow circuitry of the packing element in various embodiments comprises a manifold heat exchange fluid supply conduit having flow connections to each of the heat transfer plates in the plate array. The heat exchange fluid flow circuitry of the packing element in various embodiments may comprise a manifold heat exchange fluid discharge conduit having flow connections to each of the heat transfer plates in the plate array.

In various embodiments as hereinafter more fully described, the heat and mass transfer assembly may comprise an integrated array of multiple packing elements, such as an integrated array of multiple packing elements in which heat exchange fluid flow circuitry of each packing element is coupled with heat exchange fluid flow circuitry of at least one other packing element in the integrated array. In various embodiments, the heat and mass transfer assembly may comprise an integrated array of multiple packing elements in which flow passages between adjacent plates in at least one packing element in the integrated array are aligned with flow passages between adjacent plates in one or more other packing elements in the integrated array.

The heat and mass transfer plates may be of any suitable size and shape, and may for example be of square or rectangular shape, or of circular shape, or of other polygonal shape.

When spot weld tufted heat transfer plates are employed in the heat and mass transfer assembly, the spot welds, as previously mentioned, may have an orifice therein, through which fluid can pass in the fluid contacting operation. The orifice may be formed by mechanical forming techniques, or by laser ablation, chemical etch removal of material in the spot weld, or other suitable techniques, so that leak tightness of the spot weld tufted plate is preserved with respect to the enclosed interior passages of the plate. Accordingly, the orifice may be formed in the spot weld so that remaining portions of the spot weld circumscribe the orifice, to preserve such leak tightness.

The spot weld tufted heat transfer plates, as well as other transfer plates utilized in the heat and mass transfer assembly, e.g. brazed heat transfer plates, or plate and frame heat transfer plates, may be formed of any suitable materials of construction, including metal, polymeric material, flexible ceramic, composite materials or any other suitable material or materials appropriate to the structure and function of the heat transfer plate.

In specific embodiments, the heat transfer plates may comprise channelizing elements arranged to form channels in the interior volume of the plate to effect uniformity of distribution of the heat transfer fluid that is flowed through the interior volume, so that bypassing, dead zones, and other anonymous flow behavior or prevented.

The heat and mass transfer assembly of the disclosure may comprise an integrated array of heat and mass transfer plates, e.g., in the form of a stack of such plates or other arrangement in which the plates are consolidated with one another. For example, the integrated array of multiple heat and mass transfer plates may be provided, in which the heat exchange fluid inlets of all of the heat transfer plates are connected to a heat exchange fluid supply conduit. The integrated array of multiple heat transfer plates may be constituted in an arrangement in which the heat exchange fluid outlets of all of the heat transfer plates are connected to a heat exchange fluid discharge conduit. The heat exchange fluid supply and fluid discharge conduits may be integrated in a manifolded arrangement in the fluid flow circuitry so that the heat exchange fluid can be recirculated through the fluid flow circuitry. For such purpose, the fluid flow circuitry may be coupled exteriorly of the fluid contacting vessel with heaters, coolers, condensers, etc., to recondition the heat exchange fluid for such recirculation.

The heat transfer plates in various embodiments may have a flat or substantially flat conformation, and in other embodiments may have a wavy conformation, and in still other embodiments may have other conformations.

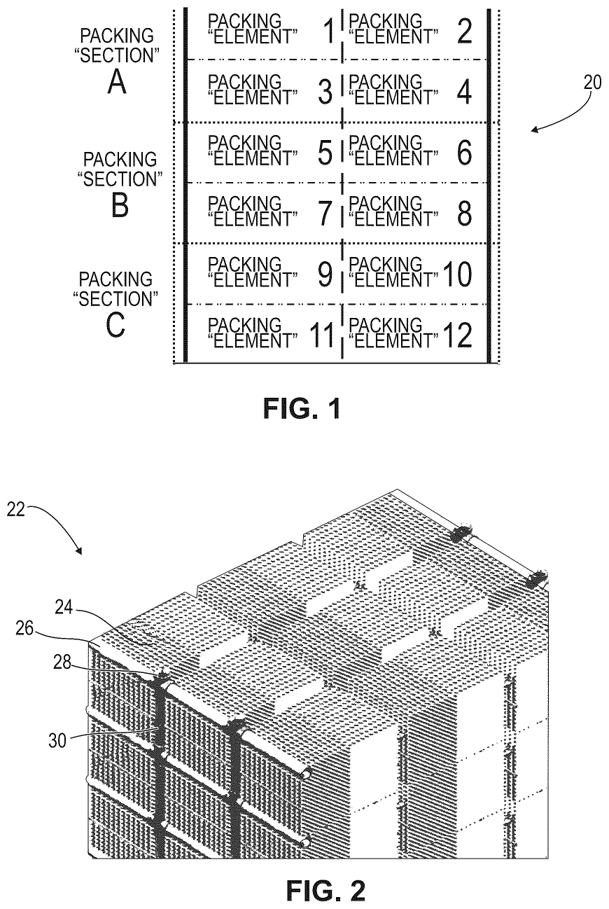

Referring now to the drawings, FIG. 1 is a schematic representation of a packing element assembly 20 comprising a plurality of packing element subassemblies 1-12, arranged as shown. In the packing element assembly, packing elements subassemblies 1-4 are integrated with one another to form packing section A, packing element subassemblies 5-8 are integrated with one another to form packing section B, and packing element subassemblies 9-12 are integrated with one another to form packing section C. The packing sections A-C are integrated with one another to aggregately form the packing element assembly. As used in such context, the term “integrated” in reference to packing element subassemblies and packing sections comprising same means that the packing element subassemblies in the packing sections and packing element assembly cooperatively allow fluids being contacted to flow through the constituent packing element subassemblies to effect mass transfer in the fluid contacting operation, and that the packing element subassemblies are arranged for flow of heat exchange fluid through heat transfer plates thereof, as described more fully hereinafter, so that the heat exchange plates of the packing element subassemblies serve to selectively modulate temperature for thermal management of the contacting operation.

FIG. 2 is a perspective view of a fluid contacting packing assembly comprising an array of heat transfer plate and mass transfer plate subassemblies, according to one embodiment of the present disclosure.

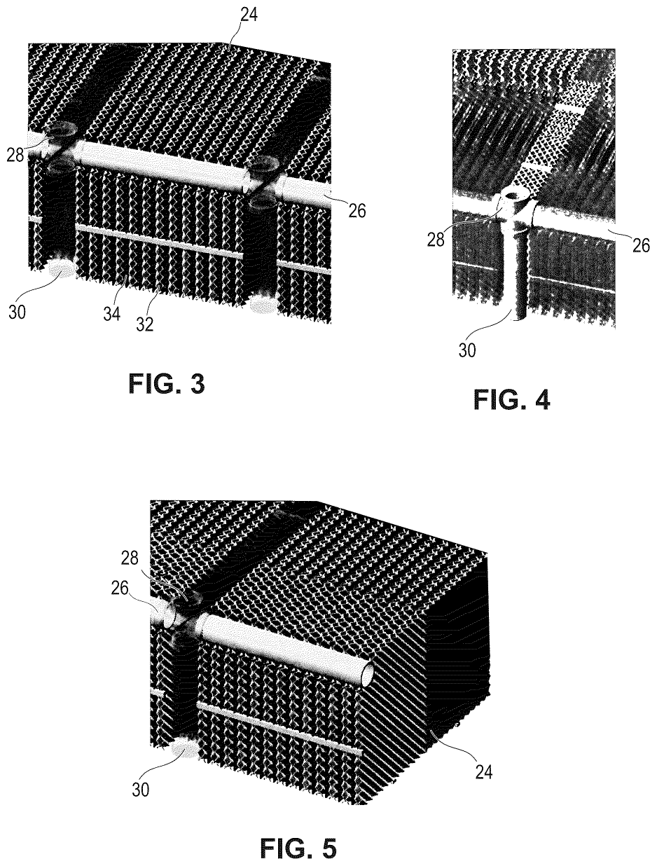

FIGS. 3-5 are perspective views of respective portions of the fluid contacting packing assembly of FIG. 2, showing details of construction thereof.

The fluid contacting packing assembly 22 as shown in FIG. 2 comprises a heat transfer plate and mass transfer plate subassembly 24 with which is associated a horizontal heat exchange conduit 26, heat exchange manifold coupling 28, and vertical heat exchange conduit 30. Conduit 26, coupling 28, and conduit 30 constitute part of a heat exchange fluid manifold for supplying heat exchange fluid to, and discharging heat exchange fluid from, the heat transfer plates 32 that alternate with mass transfer plates 34 in the fluid contacting packing assembly, as illustrated in FIG. 3. FIGS. 4 and 5 show the conduit and coupling structure of the heat exchange fluid manifold in the heat transfer plate and mass transfer plate subassembly 24.

Although the heat transfer plates 32 and mass transfer plates 34 in the fluid contacting packing assembly are illustratively depicted in the drawings as being in alternating sequence with one another (i.e., a mass transfer plate being adjacent to a heat transfer plate, which in turn is adjacent to a mass transfer plate, which in turn is adjacent to a heat transfer plate, etc.) in the assembly, the fluid contacting packing assembly may be constituted with differing numbers and ratios of mass transfer plates and heat transfer plates, as appropriate to the specific fluid contacting operation for which the fluid contacting packing assembly is deployed.

For example, it may be desirable to minimize the number of heat transfer plates in relation to the number of mass transfer plates, when the contacting operation involves only minor thermal effects associated with the contacting or otherwise from variations in temperature of the fluids being introduced to the contacting. Alternatively, when contacting thermal effects or potential temperature excursions are substantial, it may be desirable to utilize a greater number of heat transfer plates in relation to the number of mass transfer plates. It will therefore be appreciated that the numbers and ratios of mass transfer plates and heat transfer plates in relation to each other in the packing subassemblies and packing assemblies may be varied so that an appropriate number and proportion of mass transfer plates and heat transfer plates are provided in such subassemblies and assemblies.

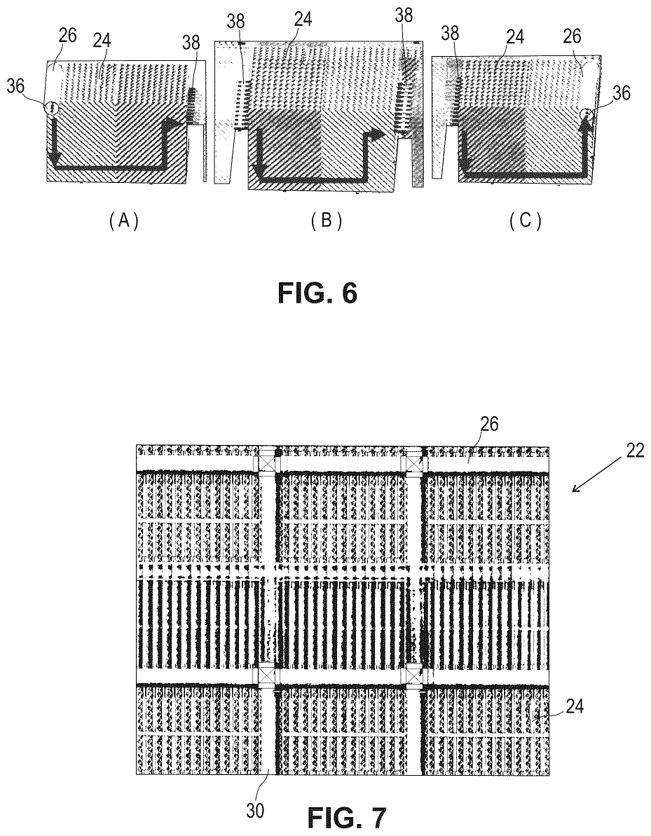

FIG. 6 is a perspective view of subassemblies (A), (B), and (C) of a fluid contacting packing assembly in which adjacent ones of the successive subassemblies 24 are interconnected by heat exchange fluid manifold connectors 38 for flow of heat exchange fluid from the horizontal heat exchange conduit 26 containing heat exchange conduit fluid passages 36 in subassembly (A) through the successive subassemblies (B) and (C) to the horizontal heat exchange conduit 26 containing heat exchange conduit fluid passages 36 in subassembly (C), with respective arrows in subassemblies (A), (B), and (C) showing the path of heat exchange fluid flow through the subassemblies.

FIG. 7 is an elevation view of a portion of a fluid contacting packing assembly 22 including a multiplicity of heat transfer plate and mass transfer plate subassemblies 24, and associated heat exchange manifold including heat exchange conduits 26 and 30.

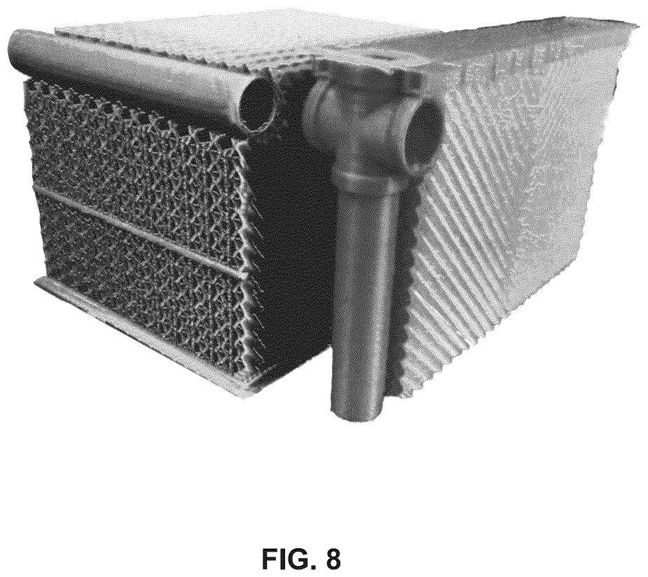

FIG. 8 is a photograph of heat transfer plate and mass transfer plate subassemblies formed by additive manufacturing for a fluid contacting packing assembly comprising the subassemblies, showing details of the structures thereof.

As will be appreciated from the foregoing description, modular heat transfer plate and mass transfer plate packing subassemblies that integrate with one another to form corresponding assemblies in which the constituent subassemblies are integrated with fluid flow circuitry for supplying heat exchange fluid to the respective subassemblies in the assembly and removing heat exchange fluid from the respective subassemblies in the assembly after the heat exchange has been completed, such as the manifold arrangements described above, have the advantage that they enable the number of connection points through the outside wall of the contacting vessel to be minimized, and thereby render installation and maintenance of the packing assembly and the constituent subassemblies thereof to be more easily carried out.

The present disclosure also contemplates arrangements of the packing assembly in which the packing assembly is mounted or supported in the contacting vessel on a base structure such as a packing support plate, below which is provided the fluid flow circuitry for supplying heat exchange fluid to the respective subassemblies in the assembly and removing heat exchange fluid from the respective subassemblies in the assembly after the heat exchange has been completed. In specific embodiments, the heat exchange fluid connections could extend below the packing support plate and connect through the wall of the contacting vessel below such packing support plate so that the heat and mass transfer packing is assembled on and/or supported by the packing support plate and the heat and mass transfer packing can be added, serviced, or removed from the contacting vessel without the heat exchange fluid flow circuitry being an obstacle in such activities.

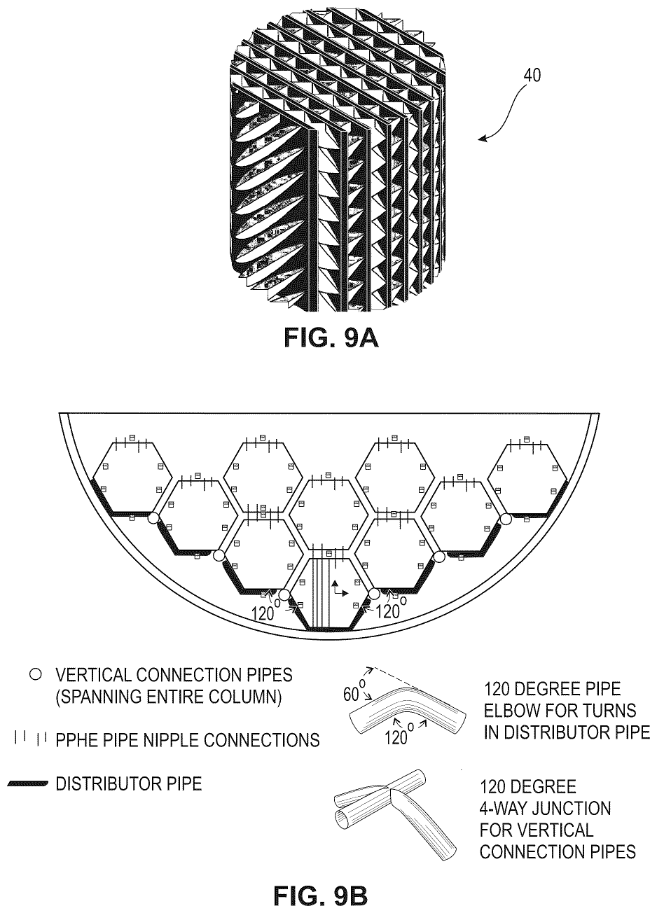

FIG. 9A is a perspective view of a fluid contacting packing assembly 40 of heat transfer plates and mass transfer plates in a cylindrical packing assembly conformation for installation in a fluid contacting vessel, according to another embodiment of the disclosure. The packing assembly 40 includes heat transfer plates and mass transfer plates that are vertically extending in the view shown in the drawing. The plates in the packing assembly are aligned with one another in the stacked array of plates in the assembly. Such cylindrical packing assembly is suitable for installation in a cylindrical fluid contacting vessel, and appropriate heat transfer fluid flow circuitry (not shown in FIG. 9A) may be integrated therewith to circulate heat transfer fluid through the heat transfer plates in the packing assembly.

FIG. 9B is a top plan view of a portion of a fluid contacting apparatus including a cylindrical vessel containing hexagonal-shaped fluid contacting packing subassemblies of heat transfer plates and mass transfer plates, arranged with flow circuitry for circulation of heat transfer fluid through the subassemblies. Each of the hexagonal-shaped fluid contacting packing subassemblies comprises a stack including corresponding hexagonal-shaped heat transfer plates and mass transfer plates, and the respective hexagonal-shaped subassemblies are nested together as shown. The heat transfer plates and mass transfer plates may be of any suitable type or types. Heat transfer fluid flow circuitry is provided for circulation of heat transfer fluid through the heat transfer plates in the subassemblies. The flow circuitry may include, for example, vertical connection pipes that are integrated with the illustrated 120° 4-way junction vertical connection pipes and 120° pipe elbows to form fluid flow circuitry manifolds, with pipe nipple connections between adjacent packing subassemblies, so that heat transfer fluid is circulated through the heat transfer plates in the subassemblies.

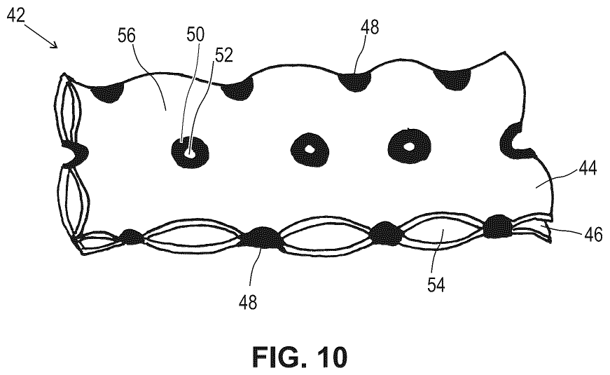

FIG. 10 shows a fluid contacting heat transfer and mass transfer plate packing element 42, according to one embodiment of the present disclosure. Such plate packing element 42 includes first wall 44 and second wall 46, which have been formed from corresponding sheets of deformable material that have been spot welded to one another by spot welds 48 and 50 across their main surfaces, followed by introduction of pressurized fluids between the spot-welded sheets, to expand the sheets in relation to each other at interior sheet surfaces between the various welding spots. The welding spots may thus be made so that they constitute an array of spaced-apart spot welds across the surfaces of the expanded first and second walls of the packing element, yielding a tufted plate conformation as illustrated. The array of spot welds may be of geometrically regular or irregular character, as appropriate to form tufted plate packing elements of desired form.

By the pressurized fluid expansion of the spot-welded sheets, the interior volume 54 thereof provides an interior heat exchange fluid flow channel through which heat exchange fluid for heating or cooling can be flowed to effect heat transfer with fluid contacting the exterior wall surface 56 of the plate packing element.

In the embodiment shown in FIG. 10, each of the spot welds 50 in the middle row of spot welds has an orifice 52 therein, to allow fluid flow therethrough during the fluid contacting operation. The orifice diameter is sufficiently smaller than the welding spot diameter so that the orifice is surrounded by a circumscribing portion of the spot weld in which the orifice has been formed, to ensure leak-tightness of the plate packing element for flow of heat transfer fluid therethrough in the interior volume 54. Orifices may be interiorly formed in all spot welds of the plate packing element, or alternatively orifices may be interiorly formed in only some of the spot welds, to enable fluid flow therethrough.

It will be appreciated that the walls of the plate element of the type illustratively shown in FIG. 10 may be welded together at an outer periphery thereof, with the respective first and second walls in registration with one another, and that suitable fluid inlet and fluid outlet structures, e.g. conduits or other flow channel members, may be integrated in fluid communication relationship with the interior volume 54 of the plate element to provide for flow of the heat exchange fluid through the interior volume of the plate element.

It will be further appreciated that a multiplicity of plate elements of the type illustratively shown in FIG. 10 may be consolidated with one another in an assembly, such as a stack of such plate elements, with the exterior wall surfaces of such elements arranged for contacting of respective fluids thereon, and flow of fluid through the orifices 52 in the plate elements in such assembly to thereby enhance the fluid contacting operation.

As an alternative to tufted plate packing elements as described above, other heat and mass transfer packing assemblies may be employed in the broad practice of the present disclosure, including for example brazed plates that define an interior heat transfer fluid flow channel therebetween through which he transfer fluid may be flowed in the contacting operation, or plate and frame heat transfer plates, or other suitable heat transfer plate members with interior heat transfer fluid flow channels may be employed.

The heat transfer plate members and mass transfer plate members may be of any suitable size, shape, configuration, and orientation. Packing assembly arrangements of such plate members may be arranged so that the heat transfer and mass transfer are effected in any suitable manner and directional character. For example, packing assembly arrangements may be constituted so that heat transfer and mass transfer are radially symmetric in character, e.g., wherein the packing assembly is of cylindrical form and is disposed in a cylindrical fluid contacting vessel, or the heat and mass transfer may be otherwise directionally oriented as a result of the specific construction and arrangement of the heat transfer plate members and mass transfer plate members.

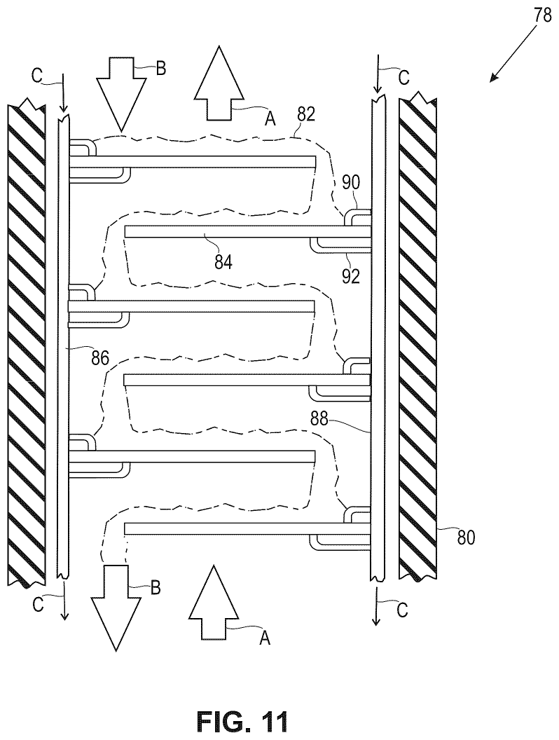

FIG. 11 is a sectional elevation view of a fluid contacting apparatus 78 including heat and mass transfer plates, according to one embodiment of the present disclosure. The fluid contacting apparatus includes a fluid contacting vessel 80 defining an interior volume therewithin in which is mounted a series of heat and mass transfer plates 84 onto which liquid contacting medium 82 is flowed, being introduced at an upper portion of the vessel in the direction indicated by upper arrow B to the uppermost heat and mass transfer plate and successively flowing across the uppermost and each successively lower heat and mass transfer plate in sequence with the liquid contacting medium falling from each upper to the next lower plate in succession as illustrated, with the liquid contacting medium at the lowermost plate being discharged downwardly in the direction indicated by lower arrow B and thereafter collected for discharge from the vessel and/or recirculation, or other disposition.

In the contacting operation conducted in the fluid contacting apparatus 78, a gas or vapor may be introduced at the lower portion of the fluid contacting vessel 80 for the contacting flowing upwardly through the vessel in the direction indicated by lower and upper arrows A. The heat and mass transfer plates 84 in the contacting vessel 80 may be tufted heat and mass transfer plates as previously described, enabling flow of the gas or vapor through the orifices in the plates for subsequent contacting with the liquid flowing across the upper plate surface. Each of the heat and mass transfer plates 84 is arranged for flow of heat exchange fluid therethrough, by heat exchange fluid flow lines 86 and 88 (in which the flow direction of the heat exchange fluid therein is indicated by arrows C). The heat exchange fluid flow lines 86 and 88 each introduce heat exchange fluid to the associated plates by heat exchange fluid supply lines 90, with the heat exchange fluid after flowing through the interior passages of the plate being discharged to the heat exchange fluid flow line by the heat exchange fluid discharge lines 92.

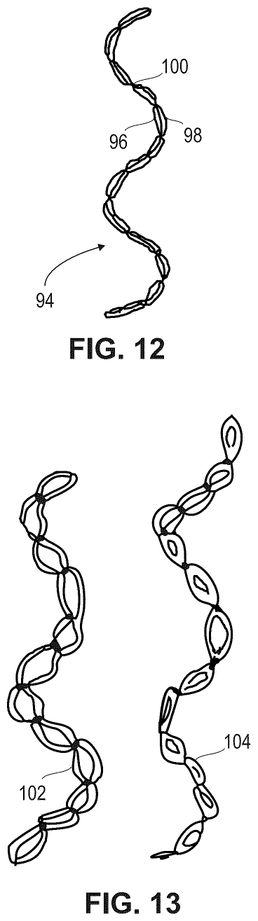

FIG. 12 is a schematic illustration of a wavy pillow plate precursor structure 94 utilized for forming wavy heat and mass transfer pillow plates, according to another aspect of the disclosure. In the precursor structure, precursor structure plate 96 and precursor structure plate 98 are spot bonded to one another at spot welds 100, with orifices being drilled or otherwise formed in such spot welds as previously described, and with the spot bonded plates being bent or otherwise formed into a sinuous, e.g., serpentine, form as illustrated. Alternatively, the precursor plates may be initially placed in registration with one another and then bent into the undulant form, following which the spot welding operation is conducted, as may be desired or preferred.

The precursor structures formed as illustratively shown in FIG. 12 may then be pressurized by introduction of pressurized fluid between the sheets intermediate the spot welds so that the sheets are pressure expanded to produce wavy pillow plates with pressure-expanded heat transfer fluid flow passages therein, as shown in the pillow plate assembly of FIG. 13 comprising wavy pillow plate 102 and wavy pillow plate 104. The wavy pillow plates thus present an undulant surface that is effective to produce turbulent flow in liquid flowed across its surface, with the orifices in the spot welds providing flow of vapor or gas therethrough into the liquid flowing in turbulent flow across the wavy pillow plate surface. As a result, a very highly efficient contacting operation is achieved, enabling the fluid contacting apparatus to be greatly reduced in size, relative to corresponding non-wavy pillow plate fluid contacting apparatus.

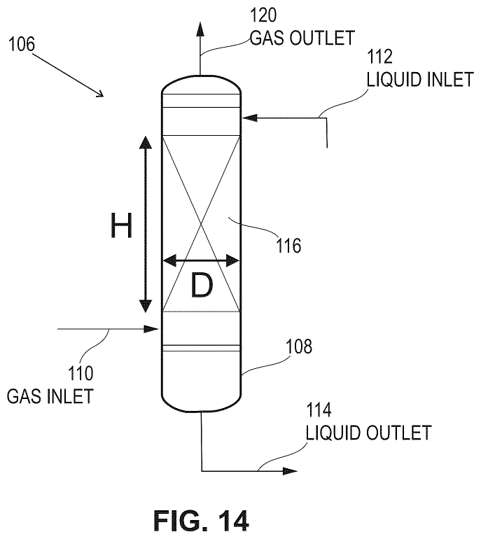

FIG. 14 is a schematic illustration of a fluid contacting apparatus 106 containing a packing assembly, according to one embodiment of the present disclosure. The fluid contacting apparatus comprises a fluid contacting vessel 108 with a gas inlet 110, a liquid inlet 112, a liquid outlet 114, and a gas outlet 120. A packing assembly 116 is disposed in the interior volume of the fluid contacting vessel, and is constructed and arranged as variously described herein, with respect to packing assemblies of the present disclosure. The packing assembly 116 as shown has a diameter D and a height H that may be varied in the broad practice of the present disclosure, to provide a packing assembly with an appropriate aspect ratio H/D for the specific fluid contacting operation being carried out in the fluid contacting vessel.

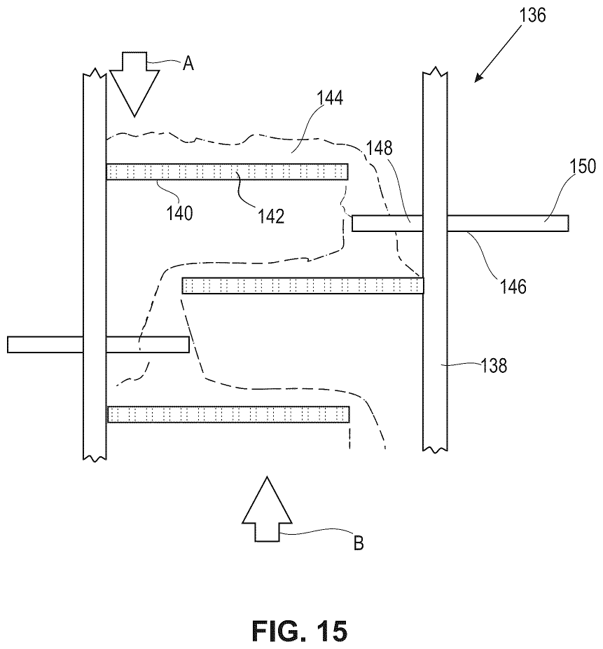

FIG. 15 is a schematic illustration of a fluid contacting apparatus 136 according to another embodiment of the present disclosure, in which fluid contacting plates 140 are disposed in the interior volume of a fluid contacting vessel 138. The fluid contacting plates 140 contain gas flow orifices 142 for gas flow therethrough to effect gas/liquid contacting with liquid introduced at arrow A for subsequent successive transverse flows across the respective fluid contacting plates and downflow from one plate to the next lower plate in the plate array in the vessel. The gas is introduced for such contacting at a lower portion of the vessel 138 for upflow in the direction indicated by arrow B, through the gas flow orifices of the successively upward fluid contacting plates in the plate array.

In the fluid contacting apparatus of FIG. 15, heat pipes 146 are arranged in the liquid downflow path between successive fluid contacting plates, to contact and thermally modulate the downflowing liquid, such heat pipes extending through the vessel wall of the fluid contacting vessel 138 to an exterior environment of the vessel. The heat pipes 146 may for example be arranged with a heat pipe vaporization section 148 thereof interiorly disposed in the vessel for contacting with the downflowing liquid to cool the downflowing liquid to maintain a predetermined set point liquid temperature or temperature range, and with the heat pipe condensation section 150 externally disposed outside the vessel, to discharge heat to the ambient environment, or to a heat sink or other heat removal device. Although shown as a single heat pipe between each of the successive fluid contacting plates, the heat pipe assembly may include multiple heat pipes, e.g., in a circumferential radially extending array of heat pipes, to contact the downflowing liquid.

The heat pipes may also be used in a reverse configuration, with the heat pipe condensation section positioned in the interior volume of the fluid contacting vessel, and with the heat pipe vaporization section positioned exterior to the contacting vessel, such as is useful to thermally manage the contacting operation when adverse endothermic reactions or conditions are presented in the contacting operation.

It will therefore be appreciated that the present disclosure encompasses a variety of packing assembly structures and subassemblies, plate configurations, and contacting vessel arrangements, which are advantageously employed to substantially enhance mass transfer and thermal management of fluid contacting operations.

It will be further appreciated that the various features, structures, and components disclosed herein may be selectively aggregated in specific combinations to provide a corresponding variety of packing assemblies, subassemblies, plates, and heat and/or mass transfer enhancement devices and systems, as will suggest themselves to persons of ordinary skill in the art based on the disclosure herein.

### LISTING OF REFERENCE NUMERALS

1-12 packing element subassemblies
20 packing element assembly
22 fluid contacting packing assembly
24 heat transfer plate and mass transfer plate subassembly
26 horizontal heat exchange conduit
28 heat exchange manifold coupling
30 vertical heat exchange conduit
32 heat transfer plate
34 mass transfer plate
36 heat exchange conduit fluid passages
38 heat exchange fluid manifold connector
40 fluid contacting packing assembly of heat transfer plates and mass transfer plates
42 fluid contacting heat transfer and mass transfer plate packing element
44 first wall of plate packing element
46 second wall of plate packing element
48 spot welds
50 spot welds
52 orifice in spot welds
54 interior volume of plate packing element
56 exterior wall surface of plate packing element
78 fluid contacting apparatus
80 fluid contacting vessel
82 liquid contacting medium
84 heat and mass transfer plate
86 heat exchange fluid flow line
88 heat exchange fluid flow line
90 heat exchange fluid plate supply linc
92 heat exchange fluid plate discharge line
94 wavy pillow plate precursor structure
96 precursor structure plate
98 precursor structure plate
100 spot weld
102 wavy pillow plate
104 wavy pillow plate
106 fluid contacting apparatus
108 fluid contacting vessel
110 gas inlet
112 liquid inlet
114 liquid outlet
116 packing assembly
120 gas outlet
122 rotating bed fluid contacting apparatus
124 rotating bed contacting chamber
126 liquid inlet
128 liquid outlet
130 gas inlet
132 gas outlet
134 fluid contacting packing assembly
136 fluid contacting apparatus
138 fluid contacting vessel
140 fluid contacting plate
142 gas flow orifices
146 heat pipe
148 heat pipe vaporization section
150 heat pipe condensation section

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

1. A heat and mass transfer assembly for a fluid contacting apparatus, the heat and mass transfer assembly comprising a packing element comprising a plate array including heat transfer plates and mass transfer plates arranged to contact respective fluids on the mass transfer plates, the heat transfer plates including interior heat exchange passages, the packing element further comprising heat exchange fluid flow circuitry connected to the heat transfer plates in the plate array to flow heat exchange fluid through the heat transfer plates in the interior heat exchange passages thereof and to discharge heat exchanged fluid from the heat transfer plates.

2. The heat and mass transfer assembly of claim 1, wherein the heat transfer plates comprise at least one plate selected from the group consisting of spot weld tufted heat transfer plates, brazed sheet heat transfer plates, and plate and frame heat transfer plates.

3. The heat and mass transfer assembly of claim 1, wherein the plate array comprises alternating heat transfer plates and mass transfer plates.

4.-5. (canceled)

6. The heat and mass transfer assembly of claim 1, wherein the packing element is of cubic form, rectangular parallelepiped form, cylindrical form, hexagonal form, or other polygonal form.

7. (canceled)

8. The heat and mass transfer assembly of claim 1, wherein the heat exchange fluid flow circuitry of the packing element comprises a manifold heat exchange fluid supply conduit having flow connections to each of the heat transfer plates in the plate array, and wherein the heat exchange fluid flow circuitry of the packing element comprises a manifold heat exchange fluid discharge conduit having flow connections to each of the heat transfer plates in the plate array.

9. (canceled)

10. The heat and mass transfer assembly of claim 1, comprising an integrated array of a multiplicity of the packing elements.

11. The heat and mass transfer assembly of claim 10, comprising at least one of the features of (1) the heat exchange fluid flow circuitry of each packing element being coupled with heat exchange fluid flow circuitry of at least one other packing element in the integrated array, and (2) flow passages between adjacent plates in the packing elements in the integrated array being aligned with flow passages between adjacent plates in one or more other packing elements in the integrated array.

12. (canceled)

13. The heat and mass transfer assembly of claim 1, wherein the heat transfer plates comprise a multiplicity of spot weld tufted heat transfer plates.

14. The heat and mass transfer assembly of claim 13, wherein spot welds on the spot weld tufted heat transfer plates define a geometrically regular array of spot welds.

15. (canceled)

16. The heat and mass transfer assembly of claim 13, wherein at least some of the spot welds on the spot weld tufted heat transfer plates have an orifice therein.

17. The heat and mass transfer assembly of claim 13, wherein at least a majority of the spot welds on the spot weld tufted heat transfer plates have an orifice therein.

18. The heat and mass transfer assembly of claim 13, wherein all or substantially all of the spot welds on the spot weld tufted heat transfer plates have an orifice therein.

19. The heat and mass transfer assembly of claim 13, wherein each of the spot weld tufted heat transfer plates has a wavy conformation.

20. The heat and mass transfer assembly of claim 1, wherein the heat transfer plates comprise at least one of (i) brazed sheet heat transfer plates, and (ii) plate and frame heat transfer plates.

21. (canceled)

22. A fluid contacting apparatus, comprising a fluid contacting vessel having disposed therein a heat and mass transfer assembly according to claim 1.

23.-24. (canceled)

25. A fluid contacting process, comprising contacting fluids to effect mass transfer from one fluid to another fluid, wherein the contacting involves or mediates thermal effects, and wherein the contacting is carried out in a heat and mass transfer assembly according to claim 1 or in a fluid contacting apparatus comprising said heat and mass transfer assembly.

26. The fluid contacting process according to claim 25, comprising at least one of absorption, regeneration, reaction, distillation, extraction, and gas-liquid contacting.

27. (canceled)

28. The fluid contacting process according to claim 25, comprising contacting of a CO₂-containing gas with a solvent to absorb CO₂ by the solvent from the CO₂-containing gas.

29. The fluid contacting process according to claim 25, wherein the contacting involves or mediates (i) exothermic thermal effects, and/or (ii) endothermic thermal effects.

30. (canceled)

31. The fluid contacting process according to claim 25, in which the heat and mass transfer assembly operatively controls a temperature bulge in a fluid contacting vessel and reduces emissions due to aerosol growth in the fluid contacting vessel.

32. A spot weld tufted heat and mass transfer plate comprising walls bonded to one another along their periphery and at spot welds spaced apart from one another so that the walls enclose and define an interior passage, a heat exchange fluid inlet and a heat exchange fluid outlet in communication with the interior passage, and an orifice in at least some of the spot welds.

33.-39. (canceled)
